(19) United States
(12) Patent Application Publication
(10) Pub. No.: US 2026/0267338 A1
(43) Pub. Date: Sep. 10, 2026

(54) UNMANNED AERIAL VEHICLE CONTROL SYSTEM AND CONTROL METHOD THEREOF

(71) Applicant: Qisda Corporation, Taoyuan City (TW)

(72) Inventor: Chien-Hsiang KAO, Taoyuan City (TW)

(73) Assignee: Qisda Corporation, Taoyuan City (TW)

(21) Appl. No.: 19/013,092

(22) Filed: Jan. 8, 2025

(30) Foreign Application Priority Data
Apr. 23, 2024 (TW) 113115098

(51) Int. Cl. G05D 1/495; G05D 1/43; G05D 109/25

(52) U.S. Cl. CPC G05D 1/495; G05D 1/43; G05D 2109/254

(57) ABSTRACT

An UAV control system includes an inclination angle detection unit, an anti-overturning unit and a processor. The inclination angle detection unit is configured to detect an inclination angle of the UAV. The anti-overturning unit is configured to stabilize the body of the UAV. The processor is configured to determine whether the UAV is in a positioning mode and determine whether the inclination angle of the body of the UAV when resisting the wind is greater than a critical value. When the UAV is in the positioning mode and the inclination angle of the body when resisting the wind is greater than the critical value, the processor records a positioning coordinate of the UAV and switches the UAV to an attitude mode. When the UAV is in the attitude mode, the processor determines whether the inclination angle of the body within an oscillation period is less than a set value.

This application claims the benefit of Taiwan application Serial No. 113115098, filed Apr. 23, 2024, the subject matter of which is incorporated herein by reference.

### BACKGROUND OF THE INVENTION

### Field of the Invention

The invention relates in general to a control system and a control method thereof, and more particularly to an unmanned aerial vehicle (UAV) control system and a control method thereof.

### Description of the Related Art

UAVs on the market, such as quad-rotor model UAVs, use a multi-layer proportional-integral-derivative (PID) controller architecture for control, such as attitude, velocity, acceleration and position control layers or the like to control UAVs, but each control layer will affect each other, so the functions of each control layer will be limited.

### SUMMARY OF THE INVENTION

The present invention relates to an UAV control system and a control method thereof to improve the flight safety of the UAV.

According to one aspect of the present invention, an UAV control method is provided, which includes the following steps. It is determined whether the UAV is in a positioning mode. It is determined whether the inclination angle of the UAV's fuselage (or body) when resisting a wind is greater than a critical value. When the UAV is in the positioning mode and the inclination angle of the body when resisting the wind is greater than the critical value, an original position of a positioning coordinate point of the UAV is recorded, and the UAV is switched to an attitude mode. When the UAV is in the attitude mode, it is determined whether the inclination angles of the body within an oscillation period are less than a set value. When the inclination angle of the body within the oscillation period is less than the set value, the UAV is switched to the positioning mode.

According to one aspect of the present invention, an UAV control system is provided. The control system includes an inclination angle detection unit, an anti-overturning unit and a processor. The inclination angle detection unit is configured to detect an inclination angle of the UAV. The anti-overturning unit is configured to stabilize the body of the UAV. The processor is configured to determine whether the UAV is in a positioning mode and determine whether the inclination angle of the body of the UAV when resisting the wind is greater than a critical value. When the UAV is in the positioning mode and the inclination angle of the body when resisting the wind is greater than the critical value, the processor records an original position of a positioning coordinate point of the UAV and switches the UAV to an attitude mode. When the UAV is in the attitude mode, the processor determines whether the inclination angle of the body within an oscillation period is less than a set value. When the inclination angle of the body within the oscillation period is less than the set value, the processor switches the UAV to the positioning mode.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a flow chart of an UAV control method according to an embodiment of the present application.

FIGS. 2A and 2B respectively illustrate a schematic diagram of an UAV switching between a positioning mode and an attitude mode according to an embodiment of the present application.

FIG. 3 is a schematic diagram of an UAV control system according to an embodiment of the present application.

### DETAILED DESCRIPTION OF THE INVENTION

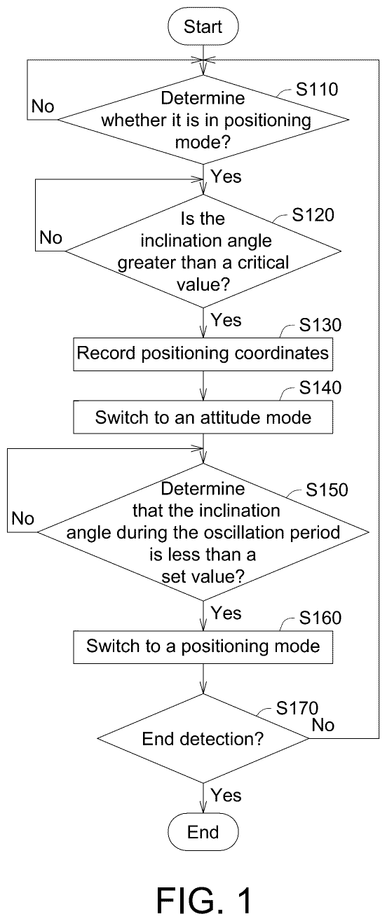

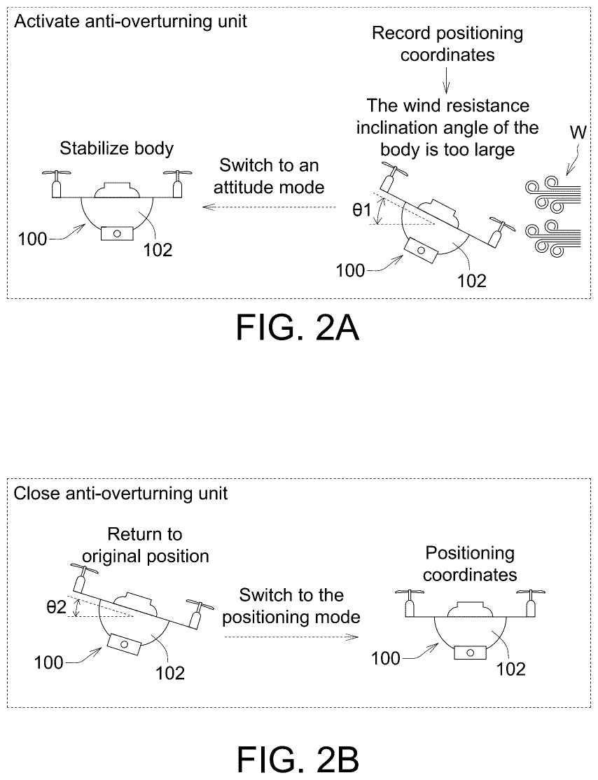

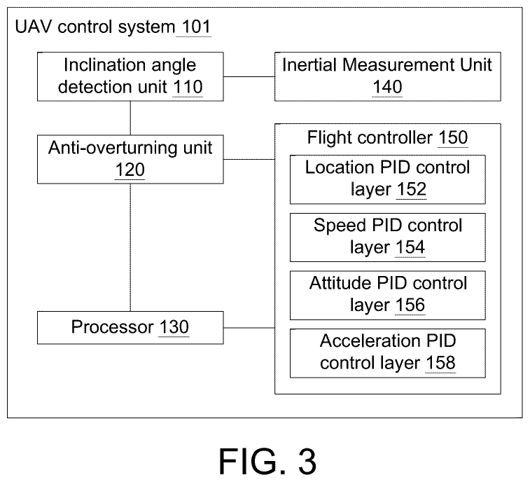

Referring to FIG. 1, FIG. 2A and FIG. 2B, FIG. 1 illustrates a flow chart of a control method of an UAV 100 according to an embodiment of the present application. FIGS. 2A and 2B respectively illustrate schematic diagrams of the UAV 100 switching between a positioning mode and an attitude mode according to an embodiment of the present application. The UAV 100 is a multi-rotor UAV such as a quad-rotor UAV or a three-rotor UAV. The UAV control method introduced below can be applied to the UAV control system 101 shown in FIG. 3 to prevent the UAV 100 from overturning when encountering strong winds in the positioning mode. After the body 102 of the UAV 100 is stabilized, the UAV 100 is controlled to return to the positioning point and switched to the positioning mode.

Referring to FIG. 1 and FIGS. 2A and 2B, the UAV control method includes the following steps S110-S170. In step S110, it is determined whether the UAV 100 is in a positioning mode. In step S120, it is determined whether the inclination angle θ1 of the body 102 of the UAV 100 when resisting a wind is greater than a critical value. In step S130, when the UAV 100 is in the positioning mode and the inclination angle θ1 of the body 102 when resisting the wind is greater than the critical value, a positioning coordinate of the UAV 100 is recorded. In step S140, the UAV 100 is switched to an attitude mode. In step S150, when the UAV 100 is in the attitude mode, it is determined whether the inclination angle θ2 of the body 102 within an oscillation period is less than a set value. In step S160, when the inclination angle θ2 of the body 102 during the oscillation period is less than the set value, the UAV 100 is switched to the positioning mode. In step S170, when the UAV 100 is switched to the positioning mode, it is confirmed whether to end the detection.

In one embodiment, the flight mode of the UAV 100 includes a positioning mode and an attitude mode. The positioning mode is mainly controlled by a position PID control layer 152, a speed PID control layer 154 and an acceleration PID control layer 158 of the flight controller 150 (as shown in FIG. 3) to keep the body 102 of the UAV 100 at a positioning coordinate point. The attitude mode is mainly controlled by an attitude PID control layer 156 of the flight controller 150 (as shown in FIG. 3) to maintain the attitude of the body 102 of the UAV 100 stable.

In one embodiment, the inclination angle θ1 of the UAV 100 when resisting wind is mainly obtained by an inclination angle detection unit 110 reading a sensing value sensed by an inertial measurement unit 140 (see FIG. 3). The inclination angle detection unit 110 may be an integrated circuit or a control chip. The inertia measurement unit 140 may be, for example, a sensor (such as an accelerometer or gyroscope) that can sense the three-axis acceleration and angular velocity of the body 102. After the sensing value is read by the inclination angle detection unit 110, the coordinate system is converted using the Euler angle to convert the sensing value into the pitch angle, roll angle and yaw angle with respect to the respective rotation axes. In one embodiment, the inclination angle θ1 of the UAV 100 when resisting the wind is mainly determined based on the pitch angle or the roll angle. When the inclination angle θ1 of the UAV 100 when resisting the wind, that is, the pitch angle or roll angle, exceeds a critical value, the body 102 of the UAV 100 is prone to overturning.

In one embodiment, when the UAV 100 is in the positioning mode and encounters strong wind W, the body 102 is tilted. If the UAV 100 is kept in the positioning mode to resist the wind, the body 102 of the UAV 100 may tilt excessively and cause overturning. Therefore, in the positioning mode, when the inclination angle θ1 of the body 102 of the UAV 100 when resisting the wind is greater than the critical value, an anti-overturning unit 120 (see FIG. 3) is activated to make the inclination angle θ1 of the body 102 when resisting the wind less than the critical value. In one embodiment, the critical value is, for example, less than or equal to 45 degrees.

Refer to FIG. 2A. In one embodiment, when the anti-overturning unit 120 is activated, the UAV 100 will be immediately switched to an attitude mode and the positioning coordinate point of the UAV 100 is recorded to stabilize the attitude of the UAV 100. That is to say, the flight mode of the UAV 100 is switched from the positioning mode to the attitude mode, and the position PID control layer 152, the speed PID control layer 154, and the acceleration PID control layer 158 of the flight controller 150 are closed, and only the attitude PID control layer 156 is activated to keep the attitude of the body 102 stable.

Refer to FIG. 2B. In one embodiment, when the UAV 100 is in the attitude mode, it is determined whether the inclination angle θ2 of the body 102 within an oscillation period is less than a set value. The inclination angle θ2 of the body 102 during the oscillation period is affected by the external wind direction and wind speed. If the inclination angle θ2 of the body 102 during the oscillation period is less than the set value, it means that the body 102 is in a stable state. In one embodiment, the oscillation period is, for example, 2 seconds or longer, and the set value is, for example, less than or equal to 5 degrees. That is to say, when the UAV 100 is switched to the attitude mode, the pitch angle or the roll angle of the UAV 100 is controlled between −5° and 5° to stabilize the body 102 of the UAV 100.

Refer to FIG. 2B. When the inclination angle θ2 of the body 102 during the oscillation period is less than the set value, the anti-overturning unit 120 is closed, the flight mode of the UAV 100 will be switched from the attitude mode to the positioning mode, and the position PID control layer 152, the speed PID control layer 154 and the acceleration PID control layer 158 of the flight controller 150 are enabled to make the UAV 100 fly toward the previously recorded positioning coordinate point of the UAV 100.

Referring to FIG. 3, a schematic diagram of a UAV control system 101 according to an embodiment of the present application is illustrated. The UAV control system 101 includes an inclination angle detection unit 110, an anti-overturning unit 120 and a processor 130. The inclination angle detection unit 110 is configured to detect the inclination angle of the UAV 100. The anti-overturning unit 120 is configured to stabilize the body 102 of the UAV 100. In one embodiment, the anti-overturning unit 120 is configured to stabilize the body 102 of the UAV 100 when the UAV 100 resists the wind. The processor 130 is configured to determine whether the UAV 100 is in a positioning mode, and determine whether the inclination angle θ1 of the body 102 of the UAV 100 when resisting the wind is greater than a critical value. In one embodiment, the inclination angle detection unit 110 and the anti-overturning unit 120 may be an integrated circuit or a control chip. In addition, the processor 130 can be implemented by a hardware (such as an integrated circuit) and/or a software (executable program). When the processor 130 is implemented by software, the processor 130 includes a memory for storing the executable program, and the processor 130 is configured to execute the UAV control method described in FIG. 1 by executing the executable program.

In steps S130 and S140, when the UAV 100 is in the positioning mode and the inclination angle θ1 of the body 102 when resisting the wind is greater than the critical value, the processor 130 records a positioning coordinate point of the UAV 100 and switches the UAV 100 to an attitude mode, as shown in FIG. 2A. In steps S150 and S160, when the UAV 100 is in the attitude mode, the processor 130 determines whether the inclination angle θ2 of the body 102 within an oscillation period is less than a set value. When the inclination angle θ2 of the body 102 during the oscillation period is less than the set value, the processor 130 switches the UAV 100 to the positioning mode, as shown in FIG. 2B.

In one embodiment, when the inclination angle θ1 of the body 102 when resisting the wind is greater than the critical value, the processor 130 activates the anti-overturning unit 120 to make the inclination angle θ1 of the body 102 when resisting the wind is less than the critical value.

In one embodiment, when the inclination angle θ2 of the body 102 during the oscillation period is less than the critical value, the processor 130 closes or disables the anti-overturning unit 120 and switches the UAV 100 to the positioning mode.

In one embodiment, when the processor 130 closes or disables the anti-overturning unit 120, the processor 130 controls the UAV 100 to fly toward the positioning coordinate point of the UAV 100 previously recorded to make the UAV 100 return to an original position.

In one embodiment, when the UAV 100 is switched to the attitude mode, the processor 130 controls the pitch angle or roll angle of the UAV 100 to be between −5° and 5°.

Refer to FIG. 3. In one embodiment, the UAV control system 101 includes an inertial measurement unit 140 and a flight controller 150. The inclination angle detection unit 110 is configured to read a sensing value sensed by the inertial measurement unit 140, and the inclination angle detection unit 110 converts the sensing value into a pitch angle, a roll angle and a yaw angle with respect to the respective rotation axes. When the pitch angle or roll angle of the UAV 100 exceeds a critical value, the body 102 of the UAV 100 is prone to overturning.

The flight controller 150 includes a position PID control layer 152, a speed PID control layer 154, an acceleration PID control layer 158 and an attitude PID control layer 156. The automatic adjustment of the parameters of the flight controller 150 is achieved through intelligent adjustment or self-correction and self-adjustment algorithms. The programmable controller (PLC) can use its closed-loop control system to implement the flight controller 150. In practical engineering applications, the most widely configured regulator control rules are proportional, integral, and differential control, referred to as PID control, where P stands for proportional control, I stands for integral control, and D stands for differential control. The PID controller uses proportional, integral, and differential controls to calculate the control amount based on the feedback error of the system. Proportional control is a simplest control method. In proportional control, the output of the flight controller 150 is proportional to the input error signal. In integral control, the output of the flight controller 150 is proportional to the integral of the input error signal. In order to eliminate the steady-state error, an “integral term” must be introduced in the flight controller 150. The integral term of the error depends on the integration of time. As time increases, the integral term will increase. In differential control, the output of the flight controller 150 is proportional to the derivative of the input error signal (i.e., the rate of change of the error) in order to overcome the problem of oscillation or even instability that may cause during the error adjustment process.

In one embodiment, the position PID control layer 152, the speed PID control layer 154, the acceleration PID control layer 158 and the attitude PID control layer 156 of the flight controller 150 respectively control the position, speed, acceleration and attitude of the UAV 100, but only relying on the multi-layered flight controller architecture to control the position, speed, acceleration and attitude of UAV 100 is still insufficient. For example, when the UAV 100 encounters a strong wind W, if the UAV 100 only relies on flight controller 150 to control the stability of body 102 in positioning mode, it is easy to cause the UAV 100 to overturn. Therefore, in the UAV control system 101 of this embodiment, the inclination angle detection unit 110 and the anti-overturning unit 120 are configured to prevent the UAV 100 from overturning when encountering a strong wind W in the positioning mode. After the body 102 of the UAV 100 is stable, the UAV 100 is controlled to return to the positioning point and switch to the positioning mode. In such way, the flight safety of UAV 100 can be effectively improved.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An unmanned aerial vehicle (UAV) control method, comprising:
determine whether the UAV is in a positioning mode;
determine whether an inclination angle of a body of the UAV when resisting a wind is greater than a critical value;
when the UAV is in the positioning mode and the inclination angle of the body when resisting the wind is greater than the critical value, recording an original position of a positioning coordinate point of the UAV and switching the UAV to an attitude mode;
when the UAV is in the attitude mode, it is determined whether the inclination angle of the body within an oscillation period is less than a set value; and
when the inclination angle of the body within the oscillation period is less than the set value, the UAV is switched to the positioning mode.

2. The method of claim 1, wherein when the UAV remains in the positioning mode, an inclination angle detection unit is configured to read a sensing value sensed by an inertial measurement unit, the inclination angle detection unit converts the sensing value into a pitch angle and a roll angle with respect to respective rotation axes.

3. The method of claim 2, wherein when the UAV is switched to the attitude mode, the pitch angle or the roll angle of the UAV is controlled to be between −5° and 5°.

4. The method of claim 1, wherein when the inclination angle of the body when resisting the wind is greater than the critical value, an anti-overturning unit is activated to make the inclination angle of the body when resisting the wind less than the critical value.

5. The method of claim 4, wherein when the inclination angle of the body during the oscillation period is less than the critical value, the anti-overturning unit is closed to switch the UAV to the positioning mode.

6. The method of claim 5, wherein when the anti-overturning unit is closed, the UAV is controlled to fly toward the positioning coordinate point of the UAV previously recorded to return to the original position.

7. The method of claim 1, wherein the critical value is less than or equal to 45 degrees.

8. The method of claim 1, wherein the set value is less than or equal to 5 degrees.

9. The method of claim 1, wherein when the UAV is switched from the positioning mode to the attitude mode, a position PID control layer, a speed PID control layer and an acceleration PID control layer of a flight controller are disabled; and/or
when the UAV is switched from the attitude mode to the positioning mode, the position PID control layer, the speed PID control layer and the acceleration PID control layer of the flight controller are enabled.

10. An unmanned aerial vehicle (UAV) control system, comprising:
an inclination angle detection unit configured to detect an inclination angle of the UAV;
an anti-overturning unit configured to stabilize a body of the UAV; and
a processor configured to determine whether the UAV is in a positioning mode and determine whether the inclination angle of the body of the UAV when resisting a wind is greater than a critical value;
wherein, when the UAV is in the positioning mode and the inclination angle of the body when resisting the wind is greater than the critical value, the processor records an original position of a positioning coordinate point of the UAV and switches the UAV to an attitude mode;
when the UAV is in the attitude mode, the processor determines whether the inclination angle of the body within an oscillation period is less than a set value;
when the inclination angle of the body within the oscillation period is less than the set value, the processor switches the UAV to the positioning mode.

11. The system of claim 10, wherein when the UAV remains in the positioning mode, the inclination angle detection unit reads a sensing value sensed by an inertial measurement unit, and the inclination angle detection unit converts the sensing value into a pitch angle and a roll angle with respect to respective rotation axes.

12. The system of claim 11, wherein when the UAV is switched to the attitude mode, the processor controls the pitch angle or the roll angle of the UAV to be between −5° and 5°.

13. The system of claim 10, wherein when the inclination angle of the body when resisting the wind is greater than the critical value, the processor activates the anti-overturning unit to make the inclination angle of the body when resisting the wind less than the critical value.

14. The system of claim 13, wherein when the inclination angle of the body during the oscillation period is less than the critical value, the processor closes the anti-overturning unit and switches the UAV to the positioning mode.

15. The system of claim 14, wherein when the processor closes the anti-overturning unit, the processor controls the UAV to fly toward the positioning coordinate point of the UAV previously recorded to make the UAV return to the original position.

16. The system of claim 10, wherein the critical value is less than or equal to 45 degrees.

17. The system of claim 10, wherein the set value is less than or equal to 5 degrees.

18. The system of claim 10, further comprising a flight controller, the flight controller comprising a position PID control layer, a speed PID control layer and an acceleration PID control layer.

19. The system of claim 18, wherein when the UAV is switched from the positioning mode to the attitude mode, the position PID control layer, the speed PID control layer and the acceleration PID control layer of the flight controller are disabled; and/or
when the UAV is switched from the attitude mode to the positioning mode, the position PID control layer, the speed PID control layer and the acceleration PID control layer of the flight controller are enabled.
